(19) United States
(12) Patent Application Publication
(10) Pub. No.: US 2024/0007280 A1
(43) Pub. Date: Jan. 4, 2024

(54) SYSTEMS AND METHODS FOR API-BASED ENCRYPTION AND KEY MANAGEMENT

(71) Applicant: UBIQ Security, Inc., San Diego, CA (US)

(72) Inventors: Wias Issa, San Diego, CA (US); Eric Tobias, San Diego, CA (US); Gary Schneir, San Diego, CA (US); Samuel Walker Craig, (US)

(73) Assignee: UBIQ Security, Inc., San Diego, CA (US)

(21) Appl. No.: 18/035,069

(22) PCT Filed: Nov. 2, 2021
(86) PCT No.: PCT/US21/57795

§ 371 Date: May 2, 2023

Related U.S. Application Data
(60) Provisional application No. 63/108,859, filed on Nov. 2, 2020.

(51) Int. Cl. H04L 9/08; H04L 67/1097

(52) U.S. Cl. CPC H04L 9/0861; H04L 9/0825; H04L 9/0891; H04L 67/1097

(57) ABSTRACT

Systems and methods are provided for creating, managing and implementing data encryption and key management in a software application through an application programming interface (API) via a SAAS-based API-based platform. A developer can quickly and easily build encryption into any application with an API accessed through an API-based platform that allows the developer to enter basic information about an application, generate encryption keys, download a client library and implement the encryption into the application based on the application information and encryption keys with only two calls to the API. The encryption is built into the software layer and the keys are managed remotely, providing security and simplicity for implementing and executing encryption. The SAAS-based API-based platform allows a developer to create and manage application profiles, encryption keys and other security parameters, application access and permissions, and incorporate Format-preserving encryption (FPE) or embedded format preserving encryption (eFPE).

### BACKGROUND

### 1. Technical Field

Various embodiments described herein relate generally to the field of electronic data security, and more particularly to creating, managing and implementing data encryption and key management in a software application through an application programming interface (API).

### 2. Related Art

Security of electronic data is of paramount importance for private individuals and for almost every conceivable business and government entity. A tremendous volume of electronic data is being generated, stored, and transmitted on a constant basis. Moreover, the breadth of electronic data, which nowadays inevitably extends to private and sensitive information, necessarily attracts a host of bad actors.

Although numerous data security methods are available, implementing a flexible roster of seamlessly integrated and complementary data security solutions for a single application remains an enormous challenge. For example, while combining security solutions will normally increase data security, incompatibilities between different solutions may in fact give rise to additional security risks.

Furthermore, most software developers are not experts in security or cryptography, which results in the selection of ineffective infrastructure-based encryption solutions, less secure applications, and loss of customer trust and reputational damage. These infrastructure-based encryption solutions—such as disk and volume-based encryption—are much less secure at the storage layer.

What is needed is a system and method that provides for simplified implementation of security and privacy controls during application development.

### SUMMARY

Systems and methods are provided for creating, managing and implementing data encryption and key management in a software application through an application programming interface (API) managed by a SAAS-based platform. The API-based platform provides a user interface for creating and implementing encryption in an application at a software layer via an API in a few steps, such that the developer can enter basic information about the application, generate encryption keys, download a client library for a specific programming language and implement the encryption into the application with only two calls to the API. Key management—including the creation, rotation and removal of master encryption keys and API keys—are managed via the API-based platform, providing security, flexibility and simplicity for implementing, executing and managing encryption. The API-based platform also provides options to create and manage application profiles and security parameters for a plurality of applications and storage locations and track encryption activity, application access and permissions. Format-preserving encryption (FPE) or embedded format preserving encryption (eFPE) may also be incorporated into the process for creating and implementing encryption via the API.

In one embodiment, a method for implementing data encryption in an application using an application programming interface (API) comprises: accessing a API-based platform for the API to create an application profile for the application; selecting an encryption scheme for the application based on the application profile; creating a set of encryption keys for the application based on the application profile; storing the set of encryption keys as credential information; installing at least one client library based on a programming language of the application; and updating the application with the API call information and credential information for encrypting data.

In another embodiment, a system for implementing data encryption in an application using an application programming interface (API) comprises: a API-based platform environment comprising: a user interface which receives application profile information, selects an encryption scheme and at least one client library, and creates a set of encryption keys for the application to store as credential information; an application environment comprising: and an application which installs the at least one client library, credential information and API call information for encrypting data.

In a further embodiment, a method for managing data encryption and key management for an application using an application programming interface (API) comprises: creating an application profile for the application on an API-based platform, wherein the application profile includes: an encryption policy for encrypting application data; a number of instances on which the application will be running; and a number of authorized applications which will be accessing the application data; displaying a dashboard for each application which includes the encryption keys, encryption policy, instances of applications running and authorized applications; and providing options to rotate, replace, add or delete encryption keys for each of the instances and authorized applications.

In a still further embodiment, a method for encrypting application data with an application programming interface (API) comprises: receiving application data from a client-side application; requesting an encryption key for the application data from an API-based platform; receiving the encryption key for encrypting the application data; encrypting the application data using the encryption key; and transmitting the encrypted application data to a data storage module.

Other features and advantages should become apparent from the following description of the preferred embodiments, taken in conjunction with the accompanying drawings.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding and shall not be considered limiting of the breadth, scope, or applicability of the embodiments. It should be noted that for clarity and ease of illustration these drawings are not necessarily made to scale.

FIG. 1 is a diagram of a SAAS-based API platform for the creation, integration and management of application-layer encryption, according to various embodiments;

FIG. 2 is a system diagram illustrating an application programming interface (API) environment for the creation, integration and management of application-layer encryption, according to various embodiments;

FIG. 3 is an illustration of the system architecture of the layers within the API environment, according to various embodiments;

FIG. 4 is a flowchart illustrating a process for registering an application and implementing application-layer encryption using the API environment, according to various embodiments;

FIG. 5 is one embodiment of a graphical user interface (GUI) of a Customer Dashboard website for implementing encryption into an application, according to various embodiments;

FIG. 6 is a combined system and method diagram illustrating the process of integrating the API-based encryption scheme into an application, according to various embodiments;

FIG. 7 illustrates a flowchart illustrating a process for encrypting data using the API-based encryption provided by the embodiments described herein, according to various embodiments;

FIG. 8 is a detailed flow diagram architecture of a method of encrypting data using the API-based platform described herein, according to various embodiments;

FIG. 9 is a detailed flow diagram architecture of a method of decrypting data using the API-based platform described herein, according to various embodiments according to various embodiments;

FIG. 10 is an image of a customer dashboard activity monitor according to various embodiments;

FIG. 11 is a GUI of one image of a Security Settings page in the Customer Dashboard which provides a developer with options for managing one or more Master Keys according to various embodiments;

FIG. 12 illustrates an administrative process and developer portal which interfaces with the customer dashboard as part of the overall platform, according to various embodiments;

FIG. 13 is a system diagram illustrating an application programming interface (API) environment for implementing format preserving encryption (FPE) or embedded format preserving encryption (eFPE), according to various embodiments;

FIG. 14 is a GUI image for creating a new field format specification (FFS), according to one embodiment of the invention.

FIG. 15 is a block diagram that illustrates a computer-embodied system according to various embodiments.

The various embodiments mentioned above are described in further detail with reference to the aforementioned figured and the following detailed description of exemplary embodiments.

### DETAILED DESCRIPTION

Certain embodiments disclosed herein provide systems and methods for creating, managing and implementing data encryption and key management in a software application through an application programming interface (API) managed by a software-as-a-service (SAAS)-based API-based platform. The API-based platform provides a user interface for creating and implementing encryption in an application at a software layer via an API in a few steps, such that the developer can enter basic information about the application, generate encryption keys, download a client library for a specific programming language and implement the encryption into the application with only two calls to the API. Key management—including the creation, rotation and removal of master encryption keys and API keys—are managed via the API-based platform, providing security, flexibility and simplicity for implementing, executing and managing encryption. The API-based platform also provides options to create and manage application profiles and security parameters for a plurality of applications and storage locations and track encryption activity, application access and permissions. Format-preserving encryption (FPE) or embedded format preserving encryption (eFPE) may also be incorporated into the process for creating and implementing encryption via the API. The system is programming language agnostic, cloud agnostic and encryption agnostic, allowing full customization of encryption schemes for any application and related devices.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

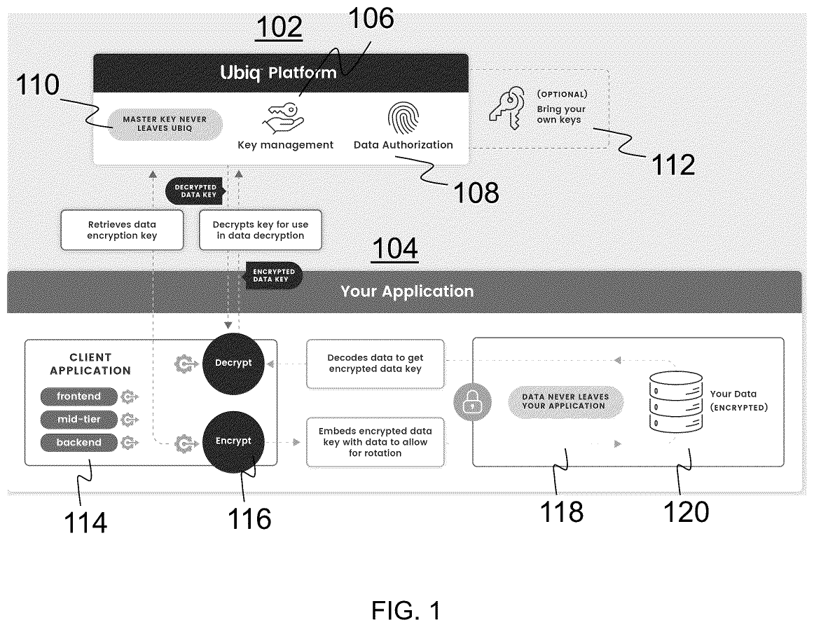

FIG. 1 is a diagram of one embodiment of a SAAS-based API platform 102 for the creation, integration and management of application-layer encryption. The API platform 102 allows a user to easily and efficiently create an encryption profile for encrypting data at the application 104, including key management 106, data authorization 108 and a master key 110. Optionally, a user can utilize existing keys 112. Once the encryption profile is complete, the platform 102 provides hosting, storage and management of the encryption keys which allows the client application 114 to communicate with the platform 102 to retrieve the encryption keys, decrypt keys for use in data decryption, and then perform encryption and decryption steps 116 with data 118 stored in data storage 120 within the application 104 that never leaves the application.

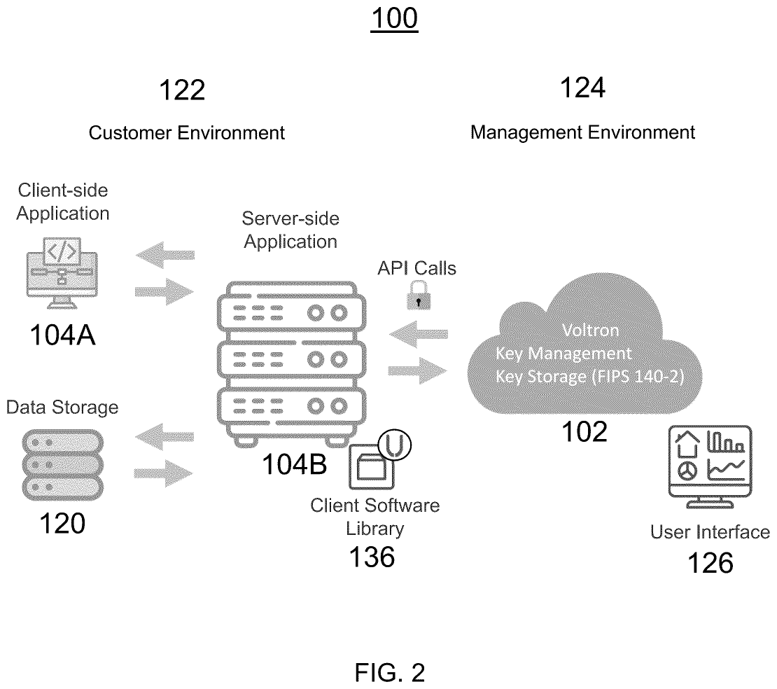

FIG. 2 is a system diagram of one embodiment of a system architecture 100 for the creation, integration and management of application-layer encryption via a SAAS-based application programming interface (API) platform illustrated in FIG. 1. In this embodiment, the system 100 may include a Customer Environment 122 which hosts various aspects and components of the application, including the application 104 which can be hosted either at a computing device 104A to provide a client-facing interface or hosted on a server 104B which manages the data and processing aspects of the application, along with the data storage device 120 which stores all of the application data for use by the application 104.

In this embodiment, a Management Environment 124 may also be provided to implement the API-based encryption and interface with the application in the Customer Environment 122, as will be described in further detail herein. The Management Environment 124 may operate as a software-as-a-service model and provide the platform 102 for various encryption-related services, such as a user interface 126 for an application developer to input application information relevant to encryption of application data, along with security parameters and information about other applications and databases which will be storing the encrypted data and which will require the necessary encryption keys. The user interface 126 in the Management Environment allows a user to easily view the encryption status, parameters, keys, activity and other analytics relating to the management of the encryption in the application. The platform 102 within the Management Environment 124 is also responsible for hosting management and storage functionality for the encryption keys generated during the process of setting up and implementing encryption of the application data. This includes the creation of a master encryption key for each application and multiple API keys that are used to securely communicate between the application and Management Environment. The keys are created, stored and managed entirely within the Management Environment to provide a secure environment separate from the customer environment for storage of the keys.

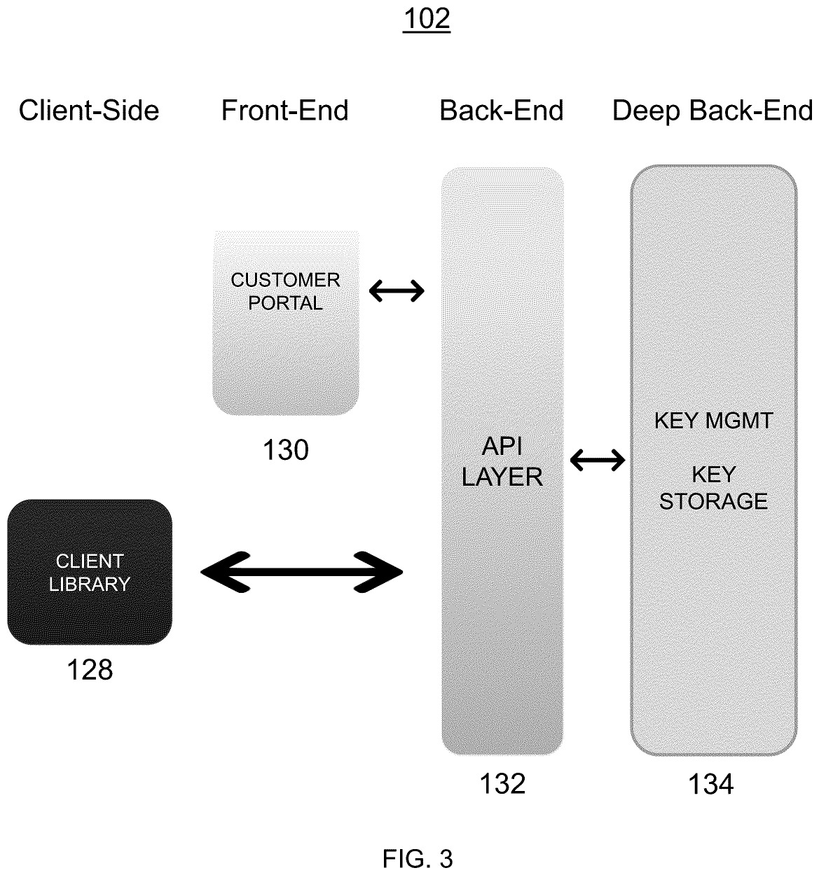

FIG. 3 is an illustration of the system architecture of the layers within the platform 102, including a client library 128 accessible at a client-side layer, a customer portal 130 at the front-end layer, the API layer 132 at a back-end layer, and the encryption key management and storage 134 at a deep back-end layer. The structure of the application layers provides increased security for the application by keeping the keys separated from the client-side or customer-facing front end, while allowing the API layer to manage communication between all three of the other layers.

As will be described in further detail below, the Customer Environment 122 interfaces with the Management Environment 124 via the application 104 to setup the overall API-based encryption and key management, at which point a client software library 136 may be downloaded to the application 104 and an initial exchange of API calls begins the process of encrypting data in the application. The system in essence creates a secure tunnel between the Customer Environment 122 and the Management Environment 124, where the application data never leaves the application 104. Once data starts flowing from the client-side application to the application (and vice-versa) through the tunnel, the system encrypts or decrypts the data using the keys stored in the Management Environment 124.

Registration, Profile Creation & API Integration

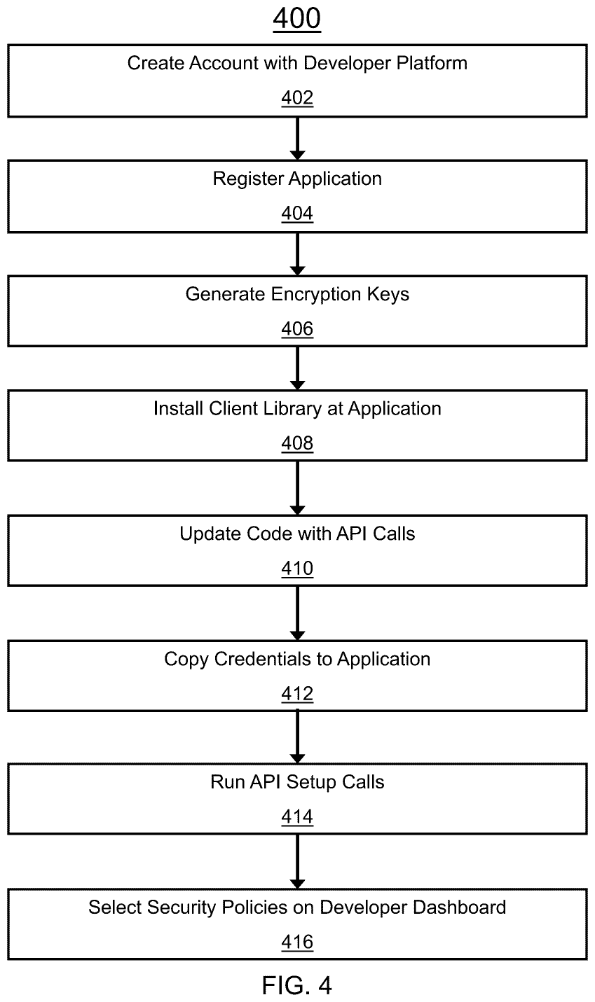

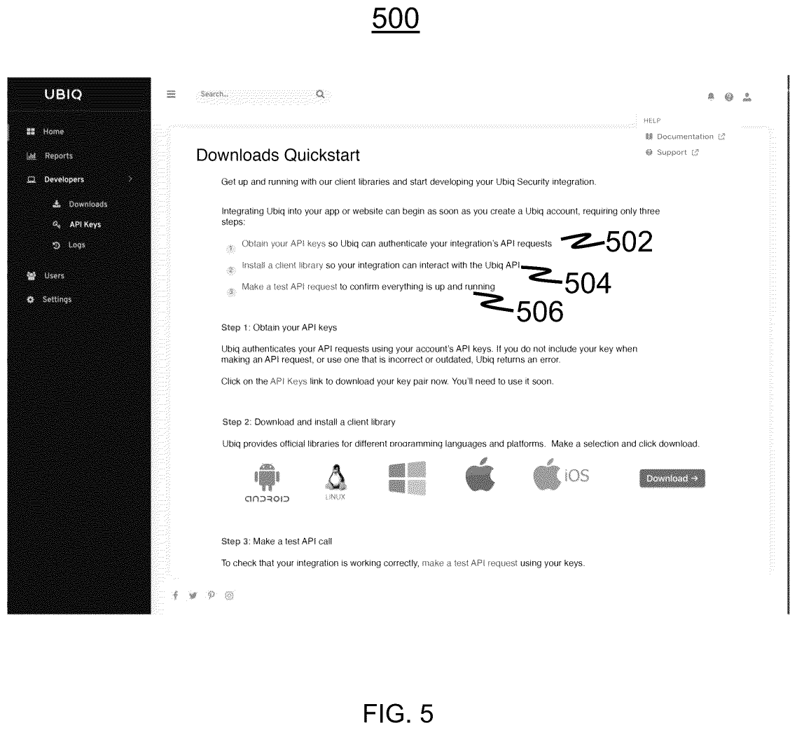

FIG. 4 is a flowchart illustrating a process 400 for registering an application by creating a user profile and application profile information for the implementation and management of application-layer encryption for one or more applications. The user may access the system via a website hosted at the Developer Site or the Customer Dashboard, and in step 402 may first create an account at the API-based platform and then register an application by entering relevant application profile information on the application in step 404. The application profile information may include an application type, programming language, data type, encryption key type, and a number of instances which require access to the application data so that each will receive a separate key, or a number of third-party applications which need secure access to the application data. The application profile information will also allow a user to create individual profiles for various aspects of an application which handle different types of data—for example, a “human resources” profile or a “customer data” profile. FIG. 5 is one embodiment of a graphical user interface (GUI) 500 provided to a user by the platform when onboarding a new user and application. The user interface 500 provides an overall summary of the process of integrating the encryption API with an application, including the steps of obtaining API keys 502, installing client libraries 504, and confirming the setup via a test API request 506.

Once the application profile information is complete, the developer only needs to integrate the encryption information into the application. The system generates encryption keys in step 406 based on the application profile information for use in encrypting the application data. A master key is generated to provide overall protection of the data and access to all of the settings and parameters for an application, whereas one or more API keys may be generated for each database, application instance or third-party application which requires encryption of the application data. In one example, the system may generate an Access Key, Secret Signing Key and Secret Crypto Access Key for each instance where the application is running. The keys are stored in a credentials file that allows the developer to easily access and copy the credential information to the application for building the API calls into the Customer Environment, as will be described in further detail below.

Depending on the programming language of a particular application, a developer may then select one or more client libraries in step 408 for installation at the application and at any other instance or third-party application, even if each location requires a different programming language and client library. The client library allows the application to integrate and interact with the API in the Management Environment. The client libraries are customized for the security platform and may be accessed via a third-party site (i.e. Gitlab) so that the most updated version of the client library can be identified and installed at the application.

With the client libraries installed, in step 410 the developer is provided with specific, step-by-step instructions for the relevant programming language on how to quickly and easily update the code of each application to execute two API calls to the Management Environment to begin encrypting application data at the application. For example, the code may require only 3 lines of instructions which: 1) perform a first API call to the Management Environment to request an encryption key for the encryption of data, 2) access the credential information at the application to authenticate the encryption request, and 3) perform a second API call to encrypt or decrypt the data. As noted herein, in order to authenticate the communication between the Management Environment and the Customer Environment, in step 412, the keys generated at the Management Environment and then copied to the application and entered as credentials that are used to validate any request from the server-side to the management side. The updated code with the API calls entered is then executed in step 414 to begin the encryption of all data passing through this system.

As part of the profile creation, in step 416 the developer can use the Customer Dashboard to view, edit and delete the security policies for each application or instance, including the need to create new keys, delete existing keys, rotate keys or perform any other form of security management.

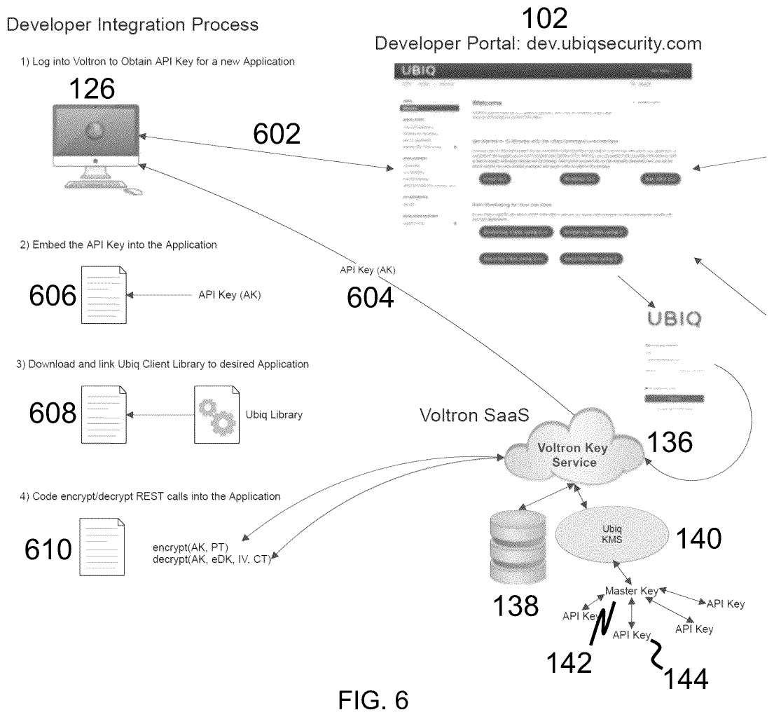

FIG. 6 is a combined system and method diagram illustrating the aforementioned process of integrating the API-based encryption scheme into an application. In the first step 602, a developer accesses the developer portal (platform) 102 via the user interface 126 to register the application and create the application profile. The portal 102 then automatically generates the appropriate encryption keys at a Key Service application 136, which communicates with a key storage database 138 and a key management service (KMS) 140 to generate and organize a Master Key 142 and at least one API Key 144. In the second step 604, the API Keys 144 are transmitted from the Key Service 140 back to the developer, after which, in step 606, the API Key 144 is embedded into the application 104. In step 608, the client library pertaining to the application programming language is downloaded and installed into the application at the application in the Customer Environment in order to add the required commands for the application to require encryption and send API calls for the keys. With the API Key and client library installed, the application can now, in step 610, communicate with the Key Service to encrypt or decrypt data passing through the application by sending API calls to the Key Service using the API Key.

Implementation of Encryption in Customer Environment

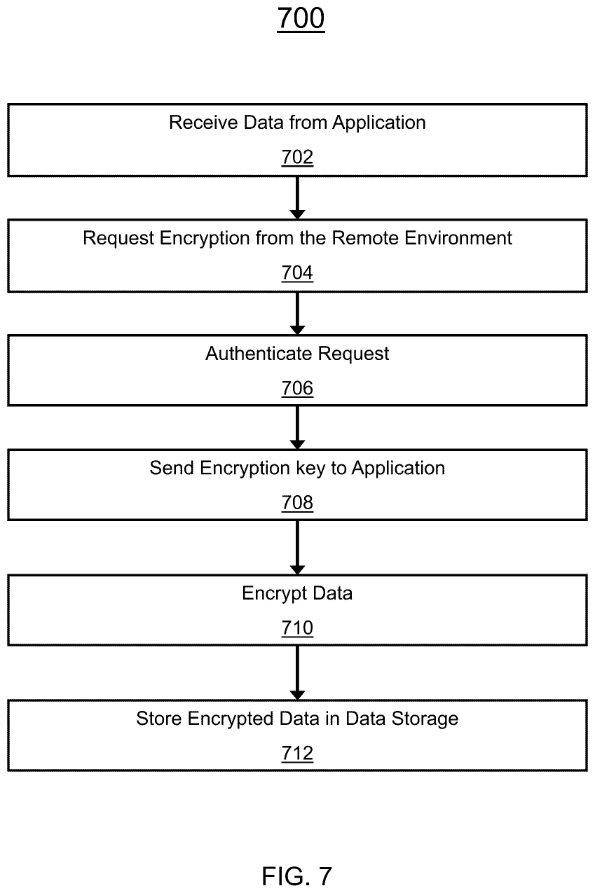

FIG. 7 is a flowchart illustrating a process 700 for encrypting data using the API-based encryption provided by the embodiments described herein. In a step 702, data from the client-side application is received at the application for either processing or storage. In step 704, the application requests an encryption key from the Management Environment, and the request is then authenticated in step 706. If the request is valid, the encryption key 708 is sent to the application for encryption of the data. Once encrypted, the data is securely stored in a data storage location.

Similarly, when encrypted data from the data storage location needs to be retrieved, the application calls for the encrypted data, sends a request to the Management Environment for the API key based on the credentials stored on the application, then receives the key for decrypting the encrypted data.

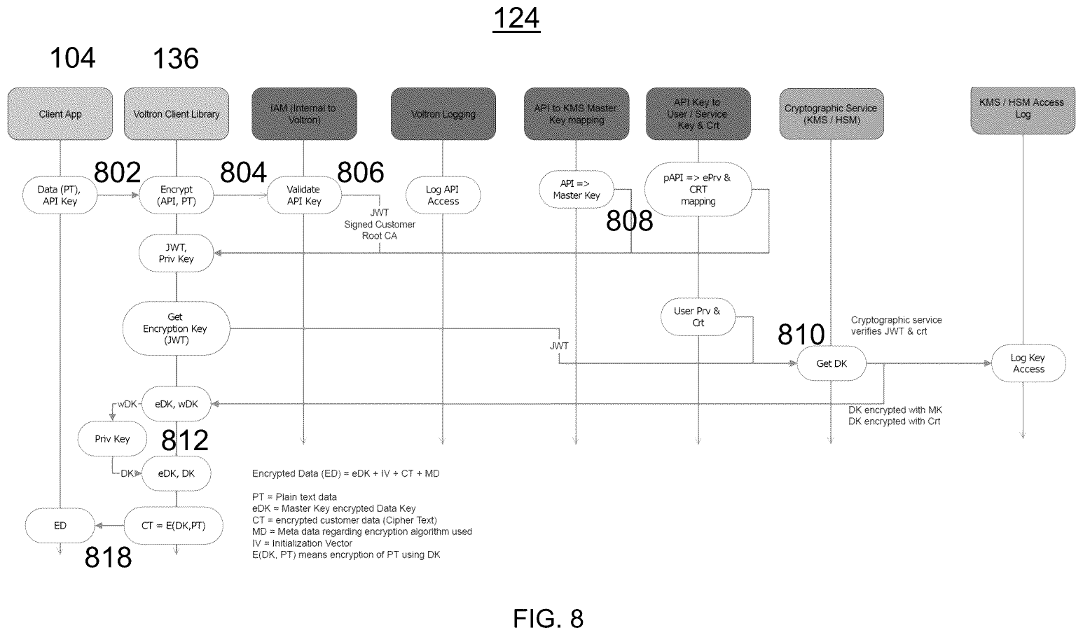

FIG. 8 is a detailed flow diagram architecture of one embodiment of a method of encrypting data using the API-based platform described herein. The flow diagram indicates the order of actions and role of each layer within the system architecture, where, in step 802, the client application 104 provides data and an API key to the client library 136, which in step 804 then passes it to a process within the Management Environment 124 to validate the API Key in step 806 and map the API Key to the Master Key in step 808. In step 810, the client library then communicates with a cryptographic service using the validated keys to encrypt data, after which in step 812 the encrypted data is decrypted with a private key at the client library that corresponds to the developer account. The client library then encrypts the data and returns it to the client application in step 814.

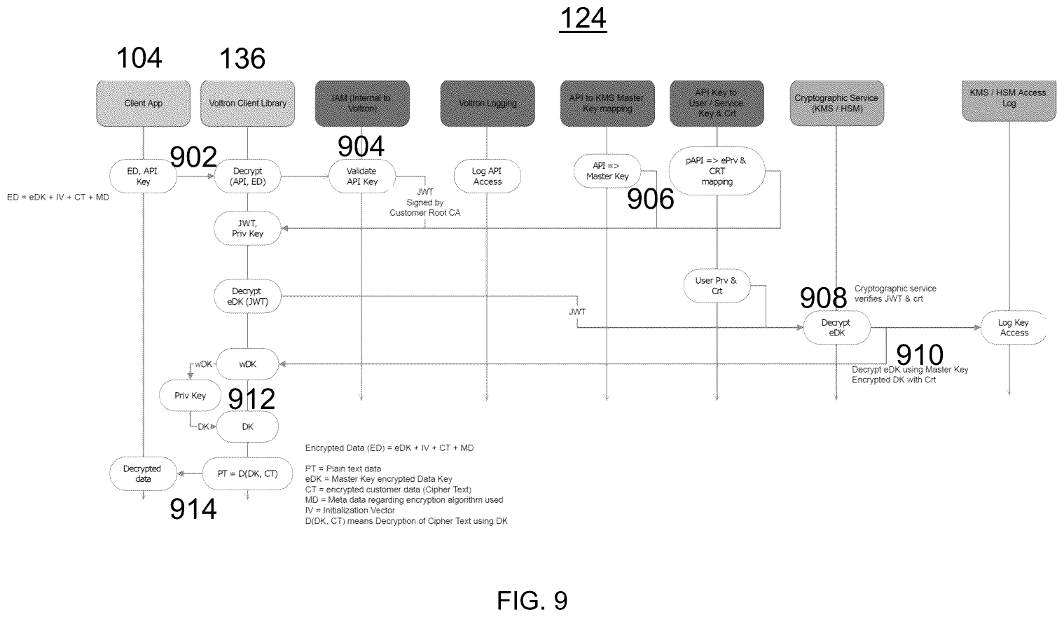

FIG. 9 is a detailed flow diagram architecture of one embodiment of a method of decrypting data using the API-based platform described herein. The flow diagram indicates the order of actions and role of each layer within the system architecture, where the client application provides data and an API key to the client library (902), which then passes it to a process within the Management Environment to validate the API Key (904) and map the API Key to the Master Key (906). The client library then communicates with a cryptographic service using the validated keys to encrypt data (908), after which the encrypted data is fully decrypted with a private key at the client library that corresponds to the developer account (910). The client library then decrypts the data (912) and returns it to the client application (914).

While the steps above describe how data which passes from the client-side application to the application is encrypted, the system also provides for retroactive encryption of application data which is already stored in data storage—whether the data was previously encrypted at the storage layer instead of the application layer, whether the data was encrypted using an old key, or whether the data was never encrypted at all. This retroactive encryption can be implemented as easily as the encryption setup process described above, using the Customer Dashboard to manually request that API calls be made to particular sets of stored data with the API keys. This process essentially mimics the process of encrypting data as it moves from the client-side application to the application even though this set of data is not being requested by the application for a particular user or use case.

Dashboard and Key Management

In one embodiment, the system provides a Customer Dashboard in the Management Environment which allows a developer to monitor, manage and view a summary of the encryption activity. The Customer Dashboard provides a summary of each application which has been registered with the system, its encryption scheme, security parameters, number of keys and application instances running in other locations or environments. More importantly, the Customer Dashboard allows the user to customize each of these parameters and settings to maintain compliance with required security protocols, customize security settings for different types of data and applications, and easily update encryption schemes for new and old data at the software layer with only a few simple steps.

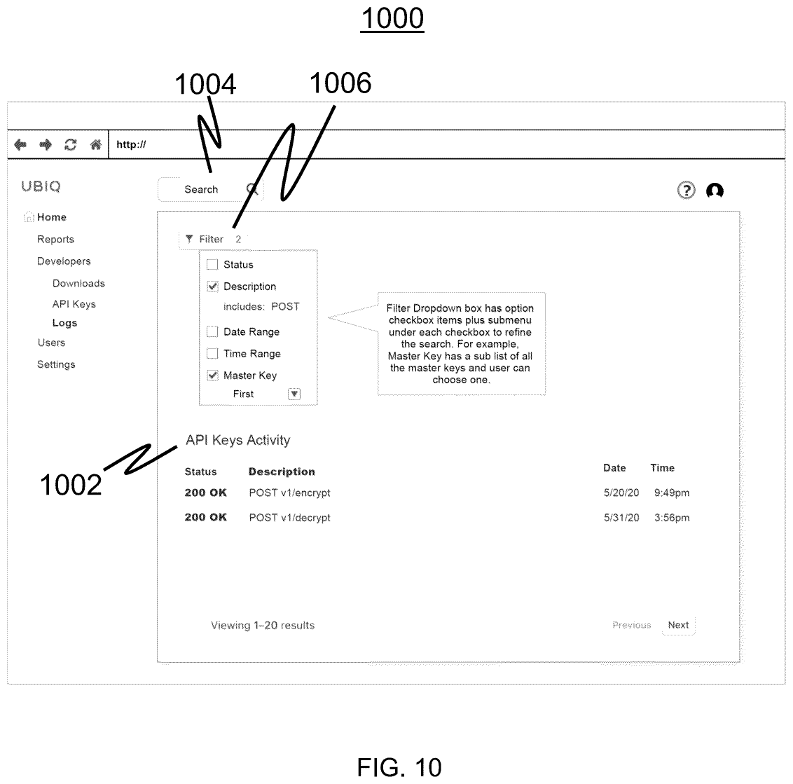

The Customer Dashboard also provides an activity monitor which shows the number of API calls being made from the application and the management environment over time in order to provide a picture of the data usage and encryption activity occurring at the application layer. The activity monitor may also be configured to identify patterns of unusual activity which may trigger the developer to rotate the encryption keys. Additional information on each application may include the application type, number of encrypts and decrypts, an application status, an API status, a usage date, a registration date, and developer registration identity. A further breakdown may provide a list of other instances or authorized applications with access to the application data. One embodiment of an image of an activity monitor 1000 is shown in FIG. 10, where activity 1002 of several API Keys is listed along with options to search 1002 for activity relating to the keys and filter 1004 the search by various time, status and key parameters to identify suspicious activity.

The Customer Dashboard also provides options to delete, disable or add an application, edit the application settings or security parameters, change an encryption scheme and add, change or delete a key rotation schedule. Additionally, the Master Key strain may be listed to show that the Master Key has been changed and provide a history of the key rotations.

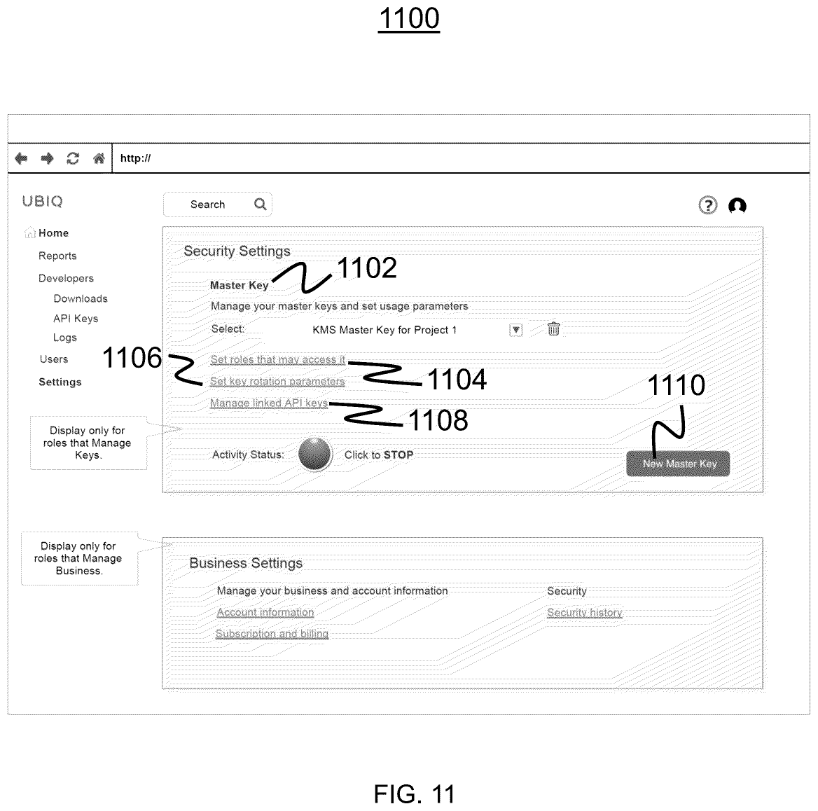

FIG. 11 is a GUI of one image of a Customer Dashboard Security Settings page 1100 which provides a developer with options for managing one or more Master Keys 1102, such as setting roles 1104 for who can access the Master Key, setting key rotation parameters 1106 and managing linked API keys 1108. Additionally, a new Master Key may be generated 1110 in this settings screen as well.

Rotating encryption keys is a feature which is built into the Customer Dashboard as an option for each application, application instance, storage location or third-party application which has access to the application data. Rotating either the API keys or the Master Key can be selected for each of the aforementioned location options, and it can be performed manually or implemented as a scheduled practice for implementation at certain time intervals to maintain compliance with security requirements for the application data.

When a key is rotated out for a new key, only data which passes through the application will be encrypted with the new key. Any old data which is still being stored within data storage but which hasn't been accessed will remain encrypted by the old key. In a typical encryption environment, re-encrypting the old data with a new key would be a lengthy and intensive task. However, the API-based encryption system described herein can update any stored data with a new encryption key by simply manually executing a new API-key call from the Customer Dashboard to the old data, which will automatically re-encrypt the old data with the new key.

The system additionally provides for rotating either the master key or the API keys separately from each other while preserving developer access and permissions. For example, if the master key is rotated, the individual API keys remain and will simply be associated with the new master key.

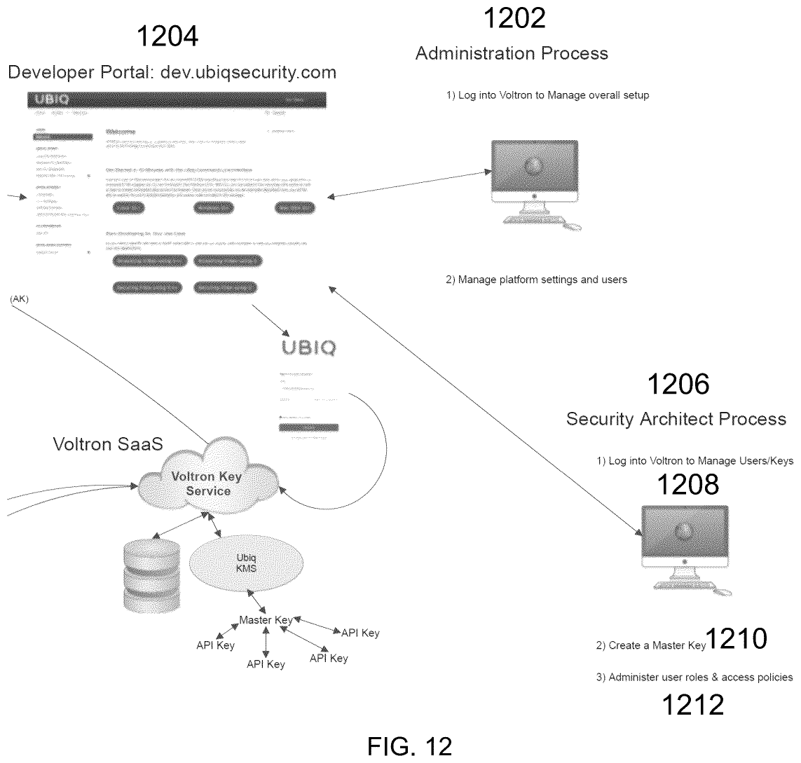

One aspect of the dashboard is illustrated by the system diagram in FIG. 12, which provides an Administration Process 1202 for interfacing with the Developer Portal 1204 to manage the overall application and encryption setup and manage platform settings and users. Additionally, a Security Architect Process 1206 allows a developer to log in to the Developer Portal to manage users and keys 1208, create a Master Key 1210, and administer roles 1212 and access policies for the application.

Format Preserving Encryption/Embedded Format Preserving Encryption

In one embodiment, the system incorporates format-preserving encryption (FPE) or embedded format preserving encryption (eFPE) into the process for creating and implementing encryption via the API. The addition of FPE/eFPE allows a user to configure and define data types to preserve the encryption and decryption abilities of existing software and systems limited by the FPE/eFPE formats, while providing the same advantages of simplifying the setup and execution of encryption. FPE/eFPE is particularly useful for encrypting cell-level data in structured databases.

FPE is the process of encrypting data by maintaining the basic format of the data. For example, an encrypted US Social Security number would still look like a US Social Security Number in terms of having 9 characters. A person's name would still look like a name with spaces between the first and last name. The use of FPE/eFPE allows the user to control the length of data (pre/post encryption), masking of data (i.e. Regex; leaving some pieces of data unencrypted), key rotation, data validation, (characters that are allowed in the data pre/post encryption), and data determinism (post-encryption, so encrypting the same data will always result in the same encrypted output).

Many users are limited in their ability to implement encryption due to software or hardware limitations relating to field format specifications (FFS), and as many of these existing limitations are similarly non-API-based, adding the capability for FPE to the previously-described API-based API-based platform will provide additional functionality and capabilities for users with unique data constraints. As with the existing API-based platform, the application data never leaves the application and allows for the same steps of generating encryption keys, downloading an appropriate client library and generation and management of encryption keys.

The term Field Format Specification (FFS) will be used herein to define the data for using FPE to encrypt a type of data element since the rules for formatting a US SSN may be different than a name, address, or financial data. When setting up the FFS for basic FPE, the user must supply a list of allowed input characters, pass through characters, a minimum string-length, and a maximum string-length. Since these values have impacts on each other, there are some rules that need to be followed when setting up FPE FFS:
1. The input character set must not contain any duplicate characters. The input character set must contain at least two characters
2. The pass through character set must not contain any duplicate characters
3. The input and pass through character sets must be disjoint, meaning that they cannot contain any of the same characters.
4. NIST standards define the minimum and maximum length of the string using the radix, length of the input character set, and the magic number 1,000,000. The rules are shown below but can be made longer in the FFS:

minlen >= 2
radix\hat{ }minlen>=1,000,000
maxlen>=minlen
2\hat{ }32 > maxlen

eFPE extends the capabilities of FPE, in several critical ways including several key features. The input character set and output character set do not have to match, meaning a US SSN can accept digits but the encrypted output may be mixed case alpha numeric. Additionally, the key used to encrypt data can be rotated over time, allowing data to encrypt using a different key.

The FFS definition for eFPE is slightly different and has slightly different rules: 1) eFPE uses an output character set so that the encrypted data may look different than the input, even though the lengths are the same; 2) the output character set and the pass through character set must be disjoint; 3) the output character set must not contain any duplicate characters; 4) in order to keep track of different keys used to encrypt the data, eFPE stores some meta-data in the encrypted data; however, since eFPE still preserves the length of the original data, the output character set must be larger than the input character set or the number of supported key rotations is limited; 5) the minimum string-length is still controlled by the formulas above for FPE; and 6) the minimum string-length, the input-radix, and output-radix all combine to control how many key rotations can be handled in the encrypted data.

If more key rotations are needed, then you may want to choose a longer minimum string length or longer output character set:

msb = (int)((radix-in \hat{ } minlen) − 1) / (radix-out \hat{ } (minlen − 1))
if (msb > 0) then
shift = ceil(log2(msg)) + 1
else
shift = 0
endif
key-rotations-allowed = out-radix >> shift

eFPE also provides for key rotation management, as it is limited and therefore calculated based on the most rotations mathematically possible by data size and embedded index of the key. The system performs the key rotation based on rules, as described in the embodiments above. An index (number) may be embedded to the key being used in the encrypted data, but the size of the encrypted data will also be kept within the maximum size allowed. When performing a decryption, the index is decoded to get the key that was used to encrypt.

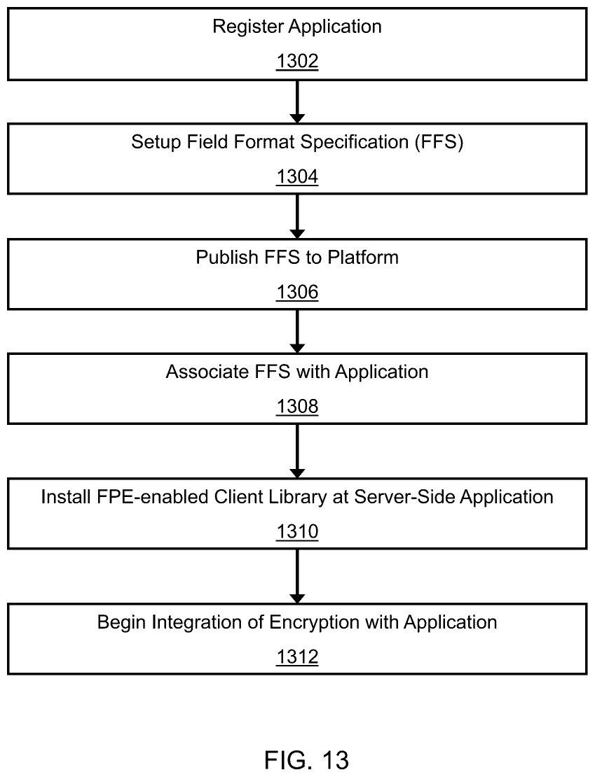

An exemplary method for incorporating FPE/eFPE within API-based platform is illustrated in the flow diagram in FIG. 13. After registering at least one application with the platform (step 1302), a first field format specification (FFS) may be created in step 1304, which is then published to the platform in step 1306. In step 1308, at least one registered application may then be associated with at least one FFS. The user may then select, download and install a FPE/eFPE enabled client library (i.e. C, Java, C#.NET) in step 1310. At this point, in step 1312 the encryption will begin to integrate with the selected application, as has been described previously.

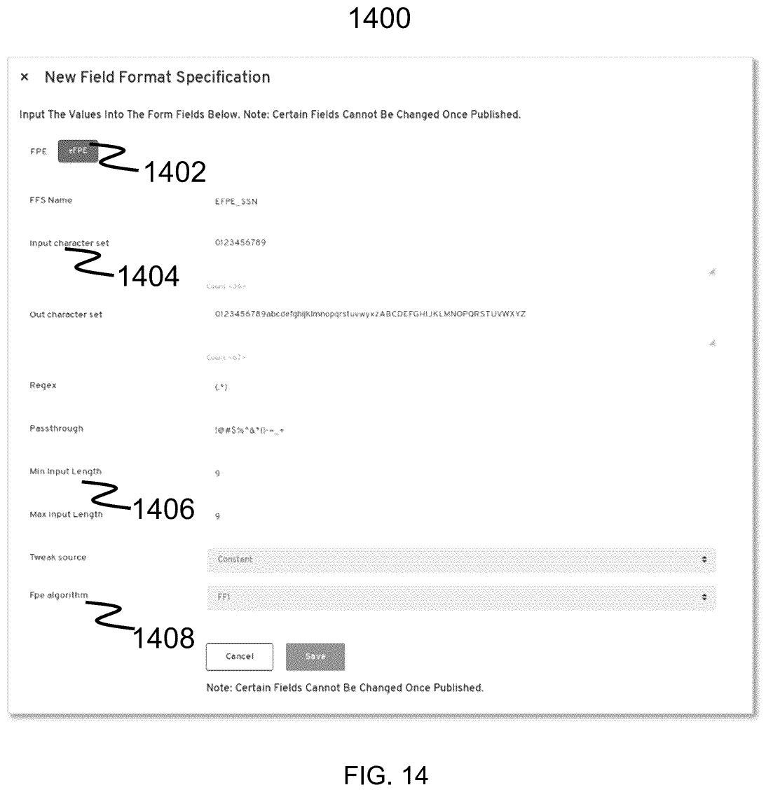

FIG. 14 illustrates one embodiment of a graphical user interface 1400 for creating a new FFS, as mentioned above with regard to step 1304. The specific type 1402 of FPE/eFPE may be selected, after which the relevant fields relevant to FFS may be selected, including the character sets 1404, format lengths 1406, algorithms 1408, etc.

In another embodiment, FPE/eFPE may be utilized in a structured data system which predefines how data is limited or defined without the need to configure encryption rules, format specifications or data types. The user would simply select “structured data” or “unstructured data,” after which the system would then pre-configure FFS for use in a general purpose format (i.e., numbers vs. text). The user would only need to identify whether the data field is numeric or string prior to executing the encryption/decryption steps. The system then translates these selections into rules for encryption to ensure the data length and encoding are properly set.

In one embodiment, the system may be configured to automatically detect the FFS of an incoming application based on the data and usage itself, then automatically select the appropriate FPE/eFPE for the user in order to simplify the setup of the application and encryption and eliminate the need to even specify the numeric or string format.

Another advantage of the FEP/eFPE is the ability to specify authorization for individual users to access individual types of data. For example, the system can be configured to give a user access to encrypt/decrypt SSNs but not credit card numbers. This authorization can even be externalized to an identity provider (IDP), such as MICROSOFT AZURE. In this embodiment, when an application is configured for use of FPE/eFPE, an FFS may be defined to describe a specific type of data, for example a credit card number or SSN. Roles may then be assigned to that FFS to control the ability to encrypt/decrypt this data.

In a further embodiment, key rotation capabilities may also be incorporated for FPE/eFPE.

Computer-Enabled Embodiment

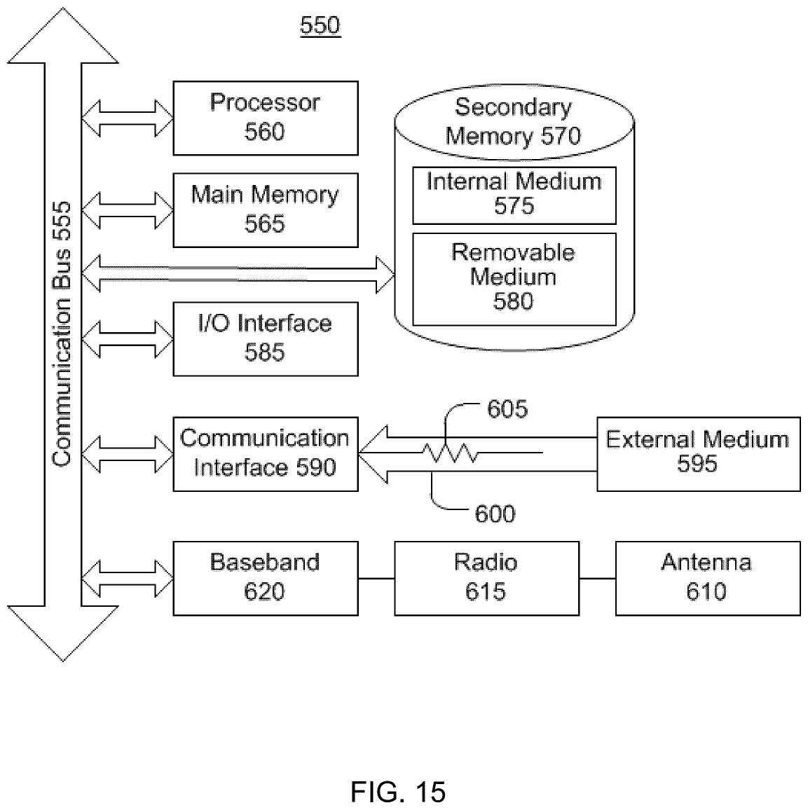

FIG. 15 is a block diagram illustrating wired or wireless system 550 according to various embodiments. Referring to FIGS. 1 and 14, the system 550 may be used to implement the secure platform.

In various embodiments, the system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, the secondary memory 570 may include other similar means for allowing computer programs or other data or instructions to be loaded into the system 550. Such means may include, for example, an external storage medium 595 and a communication interface 590. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are the removable medium 580 and a communication interface, which allow software and data to be transferred from an external storage medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. The electrical communication signals 605 are preferably provided to communication interface 590 via a communication channel 600. In one embodiment, the communication channel 600 may be a wired or wireless network, or any variety of other communication links. Communication channel 600 carries the electrical communication signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The processor 560 has access to one or more data storage areas including, for example, but not limited to, the main memory 565 and the secondary memory 570. The processor 560 is preferably configured to execute instructions (i.e., computer programs or software) that can be stored in the main memory 565 or in the secondary memory 570. Computer programs can also be received from the baseband processor 610 and stored in the main memory 565 or in the secondary memory 570, or executed upon receipt. Such computer programs, when executed, enable the system 550 to perform the various functions of the present invention as previously described. For example, the main memory 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for implementing data encryption in an application using an application programming interface (API), the method comprising:
accessing an online platform to create an application profile for the application;
selecting encryption policies for the application based on the application profile;
creating a set of encryption keys for the application based on the application profile;
storing the set of encryption keys as secret information;
creating a set of secret keys for the application to access the API;
storing the set of secret keys as credential information;
installing at least one client library based on a programming language of the application; and
updating the application with the API call information and credential information for encrypting data.

2. The method of claim 1, wherein the application profile includes a number of storage locations which store data for the application.

3. The method of claim 1, wherein the set of encryption keys includes a master encryption key and an API key.

4. The method of claim 1, wherein selecting encryption policies further comprises selecting format-preserving encryption (FPE) or embedded format preserving encryption (eFPE).

5. A system for implementing data encryption in an application using an application programming interface (API) comprising:
a platform environment comprising:
a user interface which receives application profile information, selects an encryption scheme and at least one client library, and creates a set of encryption keys for the application to store as credential information, and creates and stores a set of encryption keys;
an application environment comprising: and
an application which installs the at least one client library, credential information and API call information for encrypting data.

6. The system of claim 5, wherein the application communicates with the API-based encryption platform.

7. The system of claim 5, wherein the application environment further comprises a data storage module which receives encrypted data from the application.

8. The system of claim 5, wherein the application environment further comprises an application which transmits data for encryption.

9. The system of claim 5, wherein selecting encryption policies further comprises selecting format-preserving encryption (FPE) or embedded format preserving encryption (eFPE).

10. A method for managing data encryption and key management for an application using an application programming interface (API), the method comprising:
creating an application profile for the application on an API-based platform, wherein the application profile includes:
an encryption policy for encrypting application data;
a number of instances on which the application will be running; and
a number of authorized applications which will be accessing the application data;
displaying a dashboard for each application which includes the encryption keys, encryption policy, instances of applications running and authorized applications; and
providing options to rotate, replace, add or delete encryption keys for each of the instances and authorized applications.

11. The method of claim 10, wherein the application profile includes a number of storage locations which store data for the application.

12. The method of claim 10, wherein the set of encryption keys includes a master encryption key and an API key.

13. The method of claim 10, wherein selecting encryption policies further comprises selecting format-preserving encryption (FPE) or embedded format preserving encryption (eFPE).

14. A method for encrypting application data with an application programming interface (API), the method comprising:
receiving application data from a client-side application;
requesting an encryption key for the application data from an API-based platform;
receiving the encryption key for encrypting the application data;
encrypting the application data using the encryption key; and
transmitting the encrypted application data to a data storage module.

15. The method of claim 14, wherein the application profile includes a number of storage locations which store data for the application.

16. The method of claim 14, wherein the set of encryption keys includes a master encryption key and an API key.

17. The method of claim 14, wherein selecting encryption policies further comprises selecting format-preserving encryption (FPE) or embedded format preserving encryption (eFPE).

18. A method for decrypting application data with an application programming interface (API), the method comprising:
receiving encrypted application data from a data storage module;
requesting an encryption key for the application data from an API-based platform;
receiving the encryption key for decrypting the application data;
decrypting the application data using the encryption key; and
transmitting the decrypted application data to a client-side application.

19. The method of claim 18, wherein the application profile includes a number of storage locations which store data for the application.

20. The method of claim 18, wherein the set of encryption keys includes a master encryption key and an API key.
